(19) United States
(12) Patent Application Publication
(10) Pub. No.: US 2010/0220919 A1
(43) Pub. Date: Sep. 2, 2010

(54) Method and installation for detecting foreign bodies inside a container

(76) Inventors: Thomas Leclerc, Lyon (FR); Christophe Venaille, Saint-Genis Laval (FR); Olivier Gebelin, Bron (FR)

Correspondence Address: CLARK & BRODY, 1700 Diagonal Road, Suite 510, Alexandria, VA, 22314, US

(21) Appl. No.: 11/991,413

(22) PCT Filed: Sep. 5, 2006
(86) PCT No.: PCT/FR2006/050843

§ 371 Date: May 12, 2010

(30) Foreign Application Priority Data
Sep. 5, 2005 (FR) 0509035

(51) Int. Cl. G06K 9/00; H04N 7/18

(52) U.S. Cl. 382/142; 348/127; 348/E07.085

(57) ABSTRACT

The invention relates to an installation for detecting the presence of a foreign body (3) inside a container.

The installation includes:
means (4) for displacing the container (2) so that it occupies a characteristic position in which a foreign body (3) present is placed outside a confinement area (5) of the container,
means for displacing the container so that it occupies another characteristic position in which a foreign body present is placed in said confinement area (5) of the container,
first and second image-taking systems (10) suitable for taking at least one image of the confinement area (5) of the container when the latter occupies its characteristic positions,
and a unit for processing and analyzing images taken by the image shooting systems (10) in order to determine whether a foreign body is present or not.

The present invention relates to the technical field of inspection of translucent or transparent hollow objects or articles containing a liquid, notably of transparent or translucent nature.

The object of the invention is more specifically aimed at inspecting such containers in order to detect inside them the presence of foreign bodies in the general sense, with a density larger than that of the liquid.

The object of the invention finds a particularly advantageous application for detecting glass debris likely to be present inside containers such as bottles made in glass.

In the preferred application field above, there occurs the need of inspecting bottles in order to seek out the possible presence of glass debris. In the state of the art, there exists a first detection category aiming at setting glass debris into motion inside the container. Thus, in document WO 96/18883, a detection method was proposed in which the bottle is turned upside down so as to set the debris into motion inside the liquid. Images are successively taken within a short time interval so that by difference, the displacement of the debris may be observed.

The major drawback of this technique lies in the fact that the image shooting area should be monitored during a relatively long time interval in order to take the falling of debris into account. Such a constraint imposes either very slow working rates or many image shots and a large number of cameras. Moreover, detection is based on a difference of images which may prove to be very sensitive to noise related to actual industrial conditions such as bubbles in the liquid or drops on the wall of the bottle.

In the state of the art, there is a second detection category which aims at placing the glass debris present in a confinement area in order to limit inspection to this confinement area. Thus, Patent Application FR 2 725 274 describes an installation applying means for displacing the bottle, imposing it a sequence of movements allowing the foreign body to be placed in a stable area and without any engraving i.e. the shoulder of the bottle. Such a solution proves to be delicate to apply for bottles which have a not very pronounced shoulder. Moreover, a centrifugal force applied to the foreign bodies prevents them from remaining in a stable area of observation. It is also found that the time required for placing the foreign body in this area makes this method unusable for high inspection rates.

With the same purpose, U.S. Pat. No. 4,209,802 has proposed tilting the container relatively to the vertical by an angle of the order of 45° in order to ensure confinement of the foreign bodies in an inspection area which is part of the bottom of the container. The inspection area of the container is illuminated and the light transmitted by the container is recovered by a camera, the delivered video signal of which is analyzed in order to determine whether a foreign body is present or not. It should be considered that the confinement area of the foreign bodies corresponds to a portion of the bottle including many engravings or marks, such as notches, code pearls or molding joints. Thus, the technique proposed by this patent does not provide a reliable distinction between the foreign bodies located at the bottom of the bottle and the various markings made on the bottle, which causes rejection of bottles which do not include foreign bodies.

Analysis of the numerous solutions from the state of the art shows that there is a need for having a technique with which the presence of foreign bodies may be detected inside a container with a high inspection rate while eliminating false detections notably related to the presence of numerous markings on the containers.

The object of the invention therefore aims at proposing a method for securely and reliably detecting the presence of foreign bodies inside containers with a high inspection rate while avoiding rejection of the containers which do not include foreign bodies.

To achieve such a goal, the detection method includes the following steps:
selecting a container area, a so-called confinement area into which a foreign body present is brought by gravity,
displacing the container so as to place the foreign body present outside the confinement area,
taking at least one image of the confinement area when the container occupies a characteristic position in which the foreign body present is placed outside the confinement area,
displacing the container so as to place the foreign body in the confinement area,
taking at least one image of said confinement area when the container occupies another characteristic position in which the foreign body present is placed in the confinement area,
and analyzing the taken images in order to detect the presence of a foreign body present inside the container.

According to a first alternative embodiment, the method consists of first displacing the container so as to place the foreign body present outside the confinement area and then displacing the container so as to place the foreign body present in the confinement area.

According to a second alternative embodiment, the method consists of first displacing the container so as to place the foreign body present in the confinement area and then displacing the container so as to place the foreign body present outside the confinement area.

For example, the method consists of placing the foreign body in a confinement area of the bottle such as the bottom rim, the shoulder, the plug.

Advantageously, the method consists of taking images of the confinement area by showing a portion of the container in the image.

According to a feature of the invention, the method consists of displacing the container so as to place the foreign body present outside and within the confinement area by submitting the container to rocking movements in opposite directions.

Another object of the invention is to propose an installation for securely and reliably detecting the presence of foreign bodies inside containers with a high inspection rate while avoiding rejection of containers which do not include foreign bodies.

In order to achieve such a goal, the installation according to the invention includes:
means for displacing the container so that it occupies a characteristic position in which a foreign body present is placed outside a container area for confining said foreign body,
means for displacing the container so that it occupies another characteristic position in which a foreign body present is placed in said confinement area of the container,
a first system for taking images, suitable for taking at least one image of the confinement area of the container when the latter occupies a characteristic position,
a second system for taking images, suitable for taking at least one image of the confinement area of the container when the latter occupies its other characteristic position,
and a unit for processing and analyzing images taken by the image-taking systems in order to determine whether a foreign body is present or not.

Advantageously, the means for displacing the container so that it occupies a characteristic position, are suitable for tilting the container relatively to the vertical by a determined angle α whereas the means for displacing the container so that it occupies another characteristic position are suitable for tilting the container relatively to the vertical by an angle of a sign opposite to the determined angle α.

Still advantageously, the systems for taking images have tilted viewing axes relatively to the longitudinal axis of the container with angles of equal values and of opposite signs.

According to an exemplary embodiment, each system for taking images includes a camera and an illumination source, placed on either side of the container and suitable for detecting defects by transmission.

According to another exemplary embodiment, each system for taking images includes a camera and an illumination source suitable for detecting defects by reflection.

According to a preferred alternative embodiment, the means for displacing the container include a carousel rotating around a vertical axis and equipped with a series of means for gripping the containers distributed radially, the gripping means being controlled in displacement so that over one turn, each container occupies its two characteristic positions in which a foreign body present is placed into or outside the confinement area.

Various other features will become apparent from the description made below with reference to the appended drawings which show as non-limiting examples, embodiments of the object of the invention.

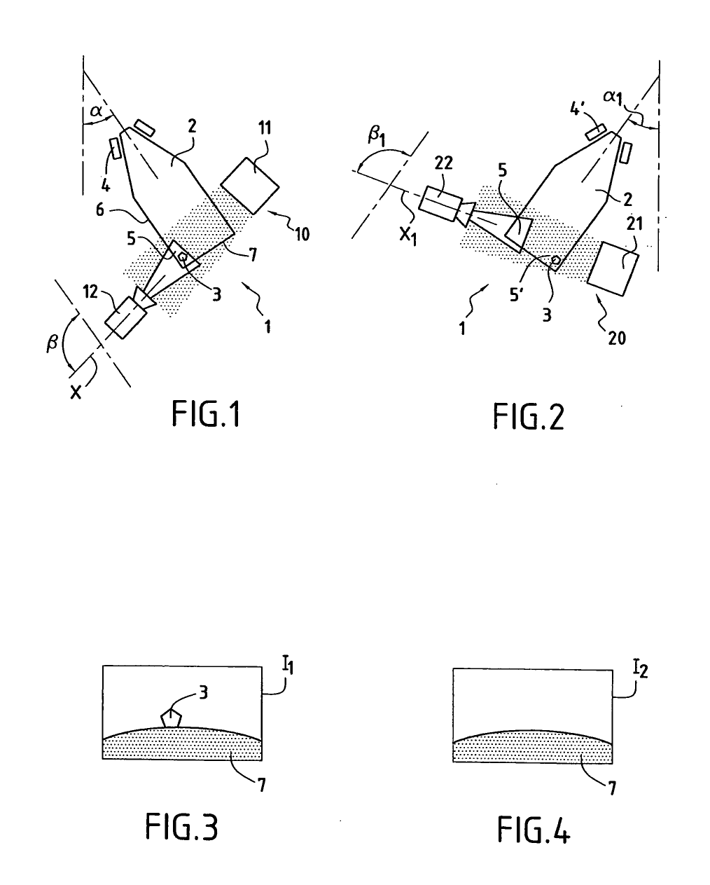

FIGS. 1 and 2 are diagrams which explain the principle of a detection installation according to the invention.

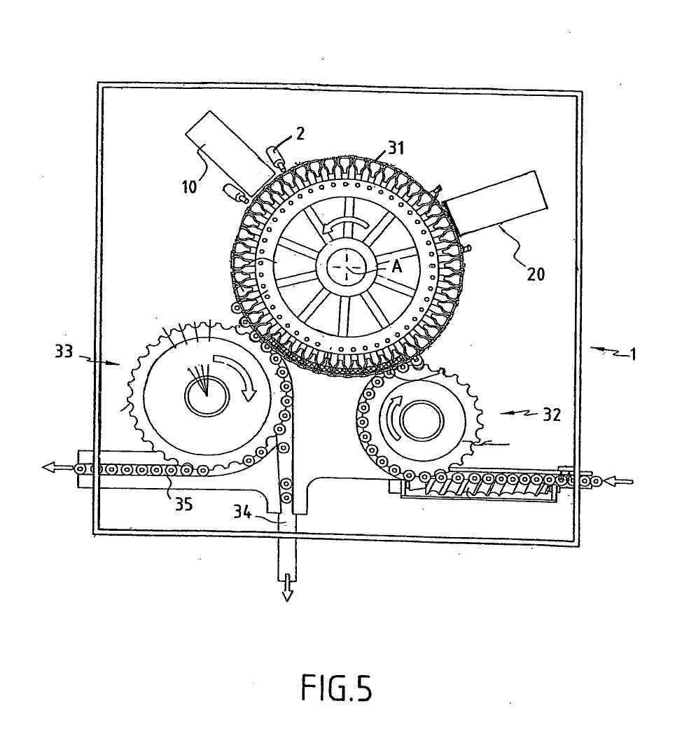

FIGS. 3 and 4 are views of examples of images taken when a container occupies characteristic positions illustrated in FIGS. 1 and 2, respectively.

FIG. 5 is a view of an exemplary embodiment of an installation according to the invention.

As this is apparent from FIGS. 1 and 2, the installation 1 according to the invention is designed so as to allow inspection of hollow articles or containers 2 made in a transparent or translucent material such as glass. In the preferred example described below, the inspected containers are bottles made in glass but it should be considered that the invention extends to any packaging for a liquid having a transparent or translucent nature, as a constitutive packaging material. The installation 1 according to the invention is designed for detecting inside the container, the presence of a foreign body 3, in the general sense, with a larger density than that of the liquid. The object of the invention finds a particularly advantageous but non-limiting application for detecting glass debris as a foreign body, but it should be considered that the object of the invention allows detection of any type of body, foreign to the liquid, with a larger density than that of the liquid.

Preferably, the detection installation 1 according to the invention is placed on the conveyor chain for the containers 2, at an inspection station located downstream from the bottling station.

According to the invention, the installation 1 includes means 4 for displacing the container 2 so that it occupies a first characteristic position, a so-called position with a foreign body, as illustrated in FIG. 1, in which a foreign body present 3 is placed inside an area 5 for confining the foreign body 3. It should be considered that the confinement area 5 corresponds to a container area into which a foreign body 3 present inside the container is brought by gravity. In the illustrated example the selected confinement area 5 is located at the junction of the body 6 and of the bottom 7 of the container also called a bottom rim. In a more specific way, the confinement area 5 corresponds to a portion of the bottom rim extending over a portion of the perimeter of the bottom rim, less than the half-perimeter of the container. Of course, another confinement area 5 may be selected in which the foreign bodies 3 are conveyed by gravity. Thus, a confinement area 5 may be selected which corresponds to the shoulder of the container or to the plug on which the foreign bodies are supported in the upside-down position of the container.

The displacement means 4 are achieved with any mechanical device with which the passage of the containers 2 on the conveyor line may be ensured from the vertical position to a first characteristic position in which a foreign body 3 present inside the container is placed inside the selected confinement area 5.

Advantageously, with the displacement means 4, the container may be tilted relatively to the vertical by a determined angle α formed between the vertical and the longitudinal symmetry axis of the bottle. For example, the angle α is comprised between 10° and 80° and preferably of the order to 50°. The tilt of the container 2 causes the possible foreign bodies 3 present to migrate towards the bottom of the container in order to settle in the confinement area 5. As this is clearly apparent from FIG. 1, the confinement area 5 corresponds for the first characteristic position of the container 2 to the portion of the bottom rim located at the lowest level.

It should be understood that the container 2 is tilted so that upon expiry of the maximum time for migration of the foreign bodies 3, the container is found placed in a position for it to be inspected. By tilting the container 2, the foreign bodies 3 may be placed in a stable area which is the bottom rim of the bottle. Inspection of this confinement area 5 is sufficient for detecting the possible presence of foreign bodies which, under the effect of gravity, are inevitably led to the bottom of the container. It should be noted that the confinement area 5 is limited relatively to the size of the bottle.

According to another feature of the invention, the installation 1 includes a first system for taking images 10 suitable for taking at least one image I₁ of the confinement area 5 of the container when the latter occupies its first characteristic position as illustrated in FIG. 1. This first system for taking images 10 includes an illumination source 11 of any known type as well as a video camera 12 of any type with which at least the confinement area 5 may be observed.

In the illustrated example, the camera 12 and the illumination source 11 are positioned on either side of a container 2. The camera 12 has a viewing axis X which is tilted by an angle β for example comprised between 90° and 135° relatively to the longitudinal axis of the container. In this example, the foreign bodies 3 are detected by transmission. Thus, the illumination is of the transmission type so that the foreign bodies 3 are revealed by attenuation of the light by an absorptive or refractive effect. Of course, reflection illumination may also be used, consisting of illuminating the foreign bodies which reflect light towards the camera. According to another alternative embodiment, applying both reflection illumination and transmission illumination may be contemplated.

The first system for taking images 10 allows at least one image to be taken when a foreign body 3 present inside the container is inevitably positioned in the confinement area 5. As this is apparent from FIG. 3, an image I₁ of the confinement area 5 shows the foreign body 3 present. According to a preferred embodiment feature, the camera 12 is placed relatively to the container so that the image taken I₁ shows a portion of the container 2 like the wall of the container corresponding to the junction between the body 6 and the bottom 7 of the container or the plug with which the container 2 is equipped. Thus, the image shows the interface area between the liquid and the container so that the portion of the container appearing on the image forms a reference area for processing images.

According to another feature of the invention particularly illustrated in FIG. 2, the installation 1 includes means 4′ for displacing the container so that it occupies a second characteristic position, a so-called position without any foreign body, in which a foreign body 3 present is placed outside the selected confinement area 5. Advantageously, with the displacement means 4′, the container may be tilted relatively to the vertical by a determined angle α₁ of an opposite sign to angle α selected for placing the container in its first characteristic position. The angle α₁ may have a value which is equal to or different from the value α. For example, the angle α₁ may be of the order of −15°.

It should be considered that the displacement means 4′ are suitable for having a foreign body 3 present inside the container brought by gravity into a positioning or recovery area 5′ which is different from the selected confinement area 5. In the example illustrated in FIG. 2, the area 5′ for recovering the foreign body 3 corresponds to a portion of the bottom rim located at the opposite portion of the bottom rim corresponding to the confinement area 5. As this is more specifically apparent from FIG. 2, in the second characteristic position of the container, the confinement area 5 corresponds to the portion of the bottom rim located at the highest level whereas the recovery area 5′ corresponds to the portion of the bottom rim located at the lowest level. The confinement 5 and recovery 5′ areas are therefore separate.

The installation 1 also includes a second system for taking images 20 suitable for taking at least one image of the confinement area 5 of the container when the latter occupies its second characteristic position illustrated in FIG. 2. This second system for taking images 20 includes an illumination source 21 of any known type and a video camera 22 also of any known type. In the illustrated example, the camera 22 and the illumination source 21 are positioned on either side of the container so that the foreign bodies are detected by transmission. Of course, it may be provided that the second system for taking images 20 includes an illumination by reflection possibly associated with an illumination by transmission. The camera 22 has a viewing axis X₁ tilted relatively to the longitudinal axis of the container by an angle β₁ with a value equal to the angle β but with an opposite sign.

With the second system for taking images 20, at least one image may be taken when a foreign body 3 present is inevitably positioned outside the selected confinement area 5. As this is apparent from FIG. 4, the image I₂ of the confinement area 5 does not include the foreign body 3. Of course, the camera 22 when the container occupies its second characteristic position, takes an image of the confinement area 5 which is identical to the confinement area 5 taken in the first characteristic position of the container. Thus, the same portion of the container 2 which appears on image I₁ appears on image I₂. The image I₂ is identical to the image I₁ with the exception of the foreign body 3.

The detection installation 1 according to the invention also includes a unit for processing and analyzing images taken by the systems for taking images 10, 20, in order to determine whether a foreign body is present or not inside the container. This unit, not shown, includes means for processing and analyzing the images I₁, I₂ taken in the two characteristic positions of the container. These means compare the images taken for detecting whether a foreign body 3 is present or not.

The installation 1 described above allows application of a detection method which directly results from the preceding description.

It should be considered that a container area, a so-called confinement area 5, is selected, into which a foreign body 3 present inside the container 2 is inevitably brought by gravity. In the illustrated example, the confinement area 5 corresponds to a portion of the bottom rim of the container.

The method consists of displacing the container 2 so as to place the foreign body 3 present inside the confinement area 5 (FIG. 1). The method consists of taking at least one image of the confinement area 5 when the container occupies this first characteristic position in which the foreign body 3 present is placed in the confinement area 5. An image I₁ showing the presence of a foreign body 3 is thereby obtained.

According to a preferred embodiment feature, the taken image takes into account at least one portion of the container, i.e. a portion of the wall or a portion of the plug in the case when the confinement area is located at the neck of the container.

The method according to the invention then consists of displacing the container so as to place the foreign body 3 present outside the selected confinement area 5. As this more specifically appears in FIG. 2, the foreign body 3 is thus placed in another portion of the bottom rim i.e. a recovery area 5′, which is separate from the selected confinement area 5. At least one image I₂ of the confinement area 5 is then taken when the container occupies this second characteristic position in which the foreign body present 5 is placed outside the confinement area (FIG. 2). As this is apparent from FIG. 4, the image taken I₂ corresponds to the same area of the container appearing in the image I₁ but in which the foreign body 3 is absent.

The images I₁, I₂ taken are then analyzed in order to detect the presence of a foreign body inside the container 2. Insofar that the images taken show the same portion of the container and possibly a foreign body 3 for the first image I₁, by comparative analysis of both images, it is possible to reveal the presence or not of a foreign body 3. The analysis of the images may consist of making a difference between the images or extracting (geometrical and photometric) characteristics of each of the images in order to compare them subsequently. It should be noted that the image I₂ free of any foreign body may form a reference image.

In the preceding description, the method aims at first displacing the container 2 so as to place the foreign body 3 present in the confinement area 5 and at then displacing the container 2 so as to place the foreign body 3 present outside the confinement area, i.e. in the recovery area 5′.

According to a preferred embodiment feature, it should be noted that the method consists of first displacing the container 2 so as to place the foreign body 3 present outside the confinement area 5 i.e. in the recovery area 5′ (FIG. 2) and of then displacing the container 2 so as to place the foreign body 3 present in the confinement area 5 (FIG. 1).

FIG. 5 illustrates an exemplary embodiment of an installation applying the method according to the invention. As this is more specifically apparent from Fig.5, the installation 1 includes a carousel rotating around a vertical axis A provided with a series of grips 31, as displacement means 4, 4′, distributed circumferentially beside each other and mounted in order to each grasp a container 2 by its neck for example. The installation includes an inlet station 32 suitable for successively bringing the containers 2 into the upright position so as to be grasped by the grips 31. The installation also includes an outlet station 33 located in proximity to the inlet station allowing containers containing foreign bodies to be transferred to an ejection outlet 34 on the one hand and the containers not including any foreign bodies 3 to be transferred to an outlet conveyor 35 on the other hand.

Between the inlet station 32 and the outlet station 33, the containers 2 successively pass in front of systems 20, 10 for taking images, which are fixed. Thus, the grips 31 are controlled in displacement so that over one turn of the carousel, each container 2 occupies both characteristic positions as defined above. Each container 2 is thus displaced so as to be placed in front of the system for taking images 20 in a tilted position so that the foreign body present 3 may be placed outside the confinement area 5 i.e. into the recovery area 5′ (FIG. 2) in order to be then displaced right up to the system for taking images 10 in which the foreign body 3 present is placed in the confinement area 5 (FIG. 1). Each container 2 is thus subject to rocking movements in opposite directions. Of course, upstream from the image-taking systems 10, 20, the container 2 may undergo various movements in order to inevitably bring all the foreign bodies 3 present into or out of the selected confinement area 5.

The invention is not limited to the described and illustrated examples because various modifications may be made thereto without departing from the scope thereof.

1. A method for detecting inside a transparent or translucent container (2) containing a liquid, the presence of a foreign body (3) with a larger density than that of the liquid, the method including the following steps:
selecting a container area, a so-called confinement area (5), into which the foreign body present is brought by gravity,
displacing the container so as to place the foreign body (3) present outside the confinement area (5),
taking at least one image (I₂) of the confinement area (5) when the container occupies a characteristic position in which the foreign body present is placed outside the confinement area,
displacing the container so as to place the foreign body in the confinement area (5),
taking at least one image (I₁) of said confinement area (5) when the container occupies another characteristic position in which the foreign body present is placed in the confinement area (5),
and analyzing the images taken (I₁, I₂) in order to detect the presence of a foreign body (3) present inside the container.

2. The method according to claim 1, characterized in that it consists of first displacing the container (2) so as to place the foreign body (3) present outside the confinement area (5) and of then displacing the container (2) so as to place the foreign body (3) present in the confinement area (5).

3. The method according to claim 1, characterized in that it consists of first displacing the container (2) so as to place the foreign body (3) present in the confinement area (5) and, of then displacing the container (2) so as to place the foreign body (3) present outside the confinement area (5).

4. The method according to claim 1, characterized in that it consists of placing the foreign body (3) in a confinement area (5) of the bottle such as the bottom rim, the shoulder or the plug.

5. The method according to claim 1, characterized in that it consists of taking images (I₁, I₂) of the confinement area (5) showing a portion of the container in the image.

6. The method according to claim 1, characterized in that it consists of displacing the container (2) so as to place the foreign body (3) present outside and in the confinement area (5) by submitting the container to rocking movements with opposite directions.

7. An installation for detecting inside a transparent or translucent container (2) containing a liquid, the presence of a foreign body (3) with a larger density than that of the liquid, the installation including:
means (4) for displacing the container (2) so that it occupies a characteristic position in which a foreign body (3) present is placed outside an area of the container (2) for confining said foreign body,
means (4′) for displacing the container so that it occupies another characteristic position in which a foreign body present is placed in said confinement area (5) of the container,
a first system for taking images (10) suitable for taking at least one image (I₁) of the confinement area (5) of the container when the latter occupies a characteristic position,
a second system for taking images (20) suitable for taking at least one image (I₂) of the confinement area of the container when the latter occupies its other characteristic position,
and a unit for processing and analyzing the images taken (I₁, I₂) by the image-taking systems (10, 20) in order to determine whether a foreign body is present or not.

8. The installation according to claim 7, characterized in that the means (4) for displacing the container (2) so that it occupies a characteristic position are suitable for tilting the container relatively to the vertical by a determined angle α whereas the means (4′) for displacing the container so that it occupies its other characteristic position are suitable for tilting the container relatively to the vertical by an angle (α₁) with a sign opposite to the determined angle α.

9. The installation according to claim 7, characterized in that the image-taking systems (10, 20) have viewing axes tilted relatively to the longitudinal axis of the container with angles of equal values and of opposite signs.

10. The installation according to claim 7, characterized in that each system for taking images (10, 20) includes a camera (12, 22) and an illumination source (11, 21), placed on either side of the container and suitable for detecting defects by transmission.

11. The installation according to claim 7, characterized in that each system for taking images (10, 20) includes a camera (12, 22) and an illumination source (11, 21) suitable for detecting defects by reflection.

12. The installation according to claim 7, characterized in that the means (4, 4′) for displacing the container include a carousel rotating around a vertical axis and equipped with a series of means (31) for grasping the containers distributed radially, the gripping means (31) being controlled in displacement so that over one turn, each container occupies both of its characteristic positions in which a foreign body (3) present is placed in or outside the confinement area (5).

13. The method according to claim 2, characterized in that it consists of placing the foreign body (3) in a confinement area (5) of the bottle such as the bottom rim, the shoulder or the plug.

14. The method according to claim 3, characterized in that it consists of placing the foreign body (3) in a confinement area (5) of the bottle such as the bottom rim, the shoulder or the plug.

15. The method according to claim 2, characterized in that it consists of displacing the container (2) so as to place the foreign body (3) present outside and in the confinement area (5) by submitting the container to rocking movements with opposite directions.

16. The method according to claim 3, characterized in that it consists of displacing the container (2) so as to place the foreign body (3) present outside and in the confinement area (5) by submitting the container to rocking movements with opposite directions.

17. The method according to claim 4, characterized in that it consists of displacing the container (2) so as to place the foreign body (3) present outside and in the confinement area (5) by submitting the container to rocking movements with opposite directions.

18. The installation according to claim 9, characterized in that each system for taking images (10, 20) includes a camera (12, 22) and an illumination source (11, 21), placed on either side of the container and suitable for detecting defects by transmission.

19. The installation according to claim 9, characterized in that each system for taking images (10, 20) includes a camera (12, 22) and an illumination source (11, 21) suitable for detecting defects by reflection.

20. The installation according to claim 10, characterized in that each system for taking images (10, 20) includes a camera (12, 22) and an illumination source (11, 21) suitable for detecting defects by reflection.

21. The installation according to claim 8, characterized in that the means (4, 4′) for displacing the container include a carousel rotating around a vertical axis and equipped with a series of means (31) for grasping the containers distributed radially, the gripping means (31) being controlled in displacement so that over one turn, each container occupies both of its characteristic positions in which a foreign body (3) present is placed in or outside the confinement area (5).
